(19) United States
(12) Patent Application Publication
(10) Pub. No.: US 2008/0023488 A1
(43) Pub. Date: Jan. 31, 2008

(54) ADDITIVE DISPENSING UNITS

(75) Inventors: Arturo F. Guerrero, Dublin, OH (US); Amol Bhalerao, Dublin, OH (US); Gary C. Helstern, Newton, CT (US)

Correspondence Address: BELL, BOYD & LLOYD LLP, P.O. Box 1135, CHICAGO, IL, 60690, US

(73) Assignee: NESTEC S.A., Vevey (CH)

(21) Appl. No.: 11/673,407

(22) Filed: Feb. 9, 2007

Related U.S. Application Data
(60) Provisional application No. 60/820,903, filed on Jul. 31, 2006.

(51) Int. Cl. B67D 5/56; B67D 5/52

(52) U.S. Cl. 222/129.4; 222/135

(57) ABSTRACT

Additive dispensing units and methods of using same are provided. In an embodiment, the modular dispensing unit comprises a support, a plurality of containers attached to the support and a plurality of pumps attached to the support. For example, each of the containers can include an additive. The pumps are operatively connected to the containers for dispensing one or more of the additives from the containers. The dispensing unit is so constructed and arranged to be attached to and operatively associated with a beverage dispensing machine.

### PRIORITY CLAIM

This application claims the benefit of U.S. Provisional Patent Application Ser. No. 60/820,903 filed on Jul. 31, 2006, the entire disclosure of which is hereby incorporated.

### BACKGROUND

The present disclosure relates generally to dispensing beverages. More specifically, the present disclosure relates to additive dispensing units and methods regarding same.

A beverage dispenser or beverage dispensing machine is a device that prepares a beverage from one or more beverage sources. In some types of beverage dispensers, beverage sources that include concentrates and/or powders are mixed with a liquid (e.g., water) to prepare the beverage. Some types of dispensers dispense relatively cold beverages (e.g., soft drinks), requiring concentrates, while other types of dispensers dispense relatively hot beverages (e.g., coffees, teas, and hot chocolates), using powders. Nevertheless, consumers usually add further ingredients such as sweeteners or flavors to the beverage to make the beverage more desirable.

### SUMMARY

The present disclosure relates to additive dispensing units and methods of using the additive dispensing units. In an embodiment, the present disclosure provides a modular dispensing unit comprising a support, a plurality of containers attached to the support and a plurality of pumps attached to the support. The containers can comprise any suitable additives. The pumps can be operatively connected to the containers for dispensing one or more of the additives from the containers. The dispensing unit can be so constructed and arranged to be attached to and operatively associated with a beverage dispensing machine.

In an embodiment, the dispensing unit can further comprise a controller operatively associated with the pumps to vary the amount of one or more additives dispensed from the containers.

In an embodiment, the dispensing unit can comprise a front panel of the beverage dispensing machine.

In an embodiment, the pumps can be so constructed and arranged in an arc formation above a dispensing area.

In an embodiment, one or more of the pumps can comprise a capillary dispensing tube for dispensing the additives.

In an embodiment, one or more of the pumps can comprise a dispensing outlet having a capillary insert for dispensing the additives.

In an embodiment, the controller can be configured for causing the dispensing unit to start dispensing one or more of the additives after and in response to the start of a base liquid dispensing by the beverage dispensing machine.

In an embodiment, the at least one dispensing tube for dispensing the additive is directed toward a stream path of the base liquid so that mixing at least partially occurs by the additive (e.g. flavor) meeting the stream path of the base liquid.

In an embodiment, the controller can be configured for causing the pumps to dispense one or more of the additives in pulses of a predetermined duration.

In an embodiment, the additives can comprise, for example, a flavoring, flavor enhancer, nutritional supplement, coffee or tea booster, flavor masker, colorant, aromatic, a substance selected for adding body to a beverage base or combinations thereof.

In an embodiment, the pumps can be in fluid communication with the containers.

In an embodiment, one or more of the containers can be releaseably attached to the support.

In an embodiment, one or more of the containers can be releaseably attached to fitments in fluid communication with the pumps.

In an embodiment, one or more of the pumps can be part of the containers.

In an embodiment, one or more of the containers can be flexible.

In an embodiment, one or more of the pumps can be releaseably attached to the support.

In an embodiment, the pumps can comprise, for example, diaphragm pumps, peristaltic pumps, syringe pumps, piston pumps, piezoelectric pumps or combinations thereof.

In another embodiment, the present disclosure provides a modular dispensing unit comprising a support, a plurality of syringes having additives attached to the support and a plurality of pressure mechanisms attached to the support. For example, the pressure mechanisms can be operatively coupled to the syringes and so constructed and arranged for dispensing one or more of the additives from the syringes by applying pressure to the syringes.

In an embodiment, the pressure mechanisms can comprise stepper motors.

In an embodiment, the syringes can be releaseably attached to the support.

In an embodiment, the dispensing unit can further comprise a controller associated with the pressure mechanisms to vary the amount of one or more additives dispensed from the syringes.

In an embodiment, the dispensing unit can further comprise a controller associated with the pressure mechanisms to retract the pressure mechanisms at the end of each dispensing cycle of the additive.

In an alternative embodiment, the present disclosure provides a modular dispensing unit comprising a support, a plurality of containers having additives attached to the support and a plurality of pressure mechanisms attached to the support. For example, the pressure mechanisms can be operatively coupled to the containers and constructed and arranged for dispensing one or more of the additives from the containers by applying pressure to the containers.

In an embodiment, the pressure mechanisms can comprise solenoid actuators.

In another embodiment, the present disclosure provides a modular dispensing unit comprising a support, a carousel hingedly attached to the support, a plurality of containers having additives attached to the carousel and a plurality of pressure mechanisms attached to the support or the carousel. For example, the pressure mechanisms can be operatively coupled to the containers and so constructed and arranged for dispensing one or more of the additives from the containers by applying pressure to the containers.

In an alternative embodiment, the present disclosure provides a modular dispensing unit comprising a support, a plurality of containers having additives attached to the support and a pump attached to the support. The pump can be operatively connected to the containers for dispensing the additives from the container. The dispensing unit can be so constructed and arranged to be attached to and operatively associated with a beverage dispensing machine.

In another embodiment, the present disclosure provides a method of preparing a beverage. For example, the method can comprise providing or dispensing a base liquid from a beverage dispensing machine in a beverage holder; dispensing a plurality of additives from a modular additive dispensing unit into the beverage holder or into a dispensed base liquid stream to mix the additives with the base liquid to provide a beverage wherein the additives are dispensed from a plurality of containers by a plurality of pumps operatively connected to the containers; and controlling the dispensing of additives to vary the concentration of the additives in the base liquid in the beverage holder during the dispensing. The modular additive dispensing unit can be operatively associated with the beverage dispensing machine

In an embodiment, the method can further comprise dispensing the base liquid and additives for predetermined time periods automatically in response to operating a dispensing control.

In an embodiment, the additives can be dispensed in a plurality of pulses of predetermined durations, the base liquid being dispensed at least before and at the beginning of the pulses.

In an embodiment, the additives can be dispensed from fewer than all of the plurality of containers to make a single beverage.

In an embodiment, one or more of the pumps are removably attached to the dispensing unit for disposal or recycling. In another embodiment, at least one portion of the pump is a part of the container. In an alternative embodiment, the pump comprises a syringe forming a container for the additives.

In an embodiment, the method can further comprise operating a selection control of the beverage dispensing machine to select one or more of the additive containers from which to dispense the additive.

In an embodiment, the concentrate beverage component can comprise, for example, protein-enriched liquid, juice, coffee, tea, cocoa, milk, a cereal or combinations thereof.

In an embodiment, the beverage component can comprise an ingredient such as a coffee, cocoa, or tea base, a sweetener, a whitener or combinations thereof.

In an embodiment, the whitener can comprise a component such as a non-dairy creamer, a dairy creamer or combinations thereof.

In an alternative embodiment, the present disclosure provides a method of preparing a beverage. In this embodiment, the method can comprise mixing a concentrate beverage component with a first liquid to provide a base liquid; dispensing the base liquid from a beverage dispensing machine into a beverage holder; dispensing a plurality of additives from a modular additive dispensing unit into the beverage holder or into a dispensed base liquid stream to mix the additives with the base liquid during the dispensing of the base liquid to provide a beverage, wherein the additives are dispensed from a plurality of containers by a plurality of pumps operatively connected to the containers; and controlling the dispensing of additives to vary the concentration of the additives in the base liquid in the beverage holder during the dispensing. The modular additive dispensing unit can be operatively associated with the beverage dispensing machine

An advantage of the present disclosure is to provide a modular unit for dispensing one or more additives.

Another advantage of the present disclosure is to provide an additive dispensing unit adapted to fit to a variety of beverage dispensing machines.

Yet another advantage of the present disclosure is to provide an additive dispensing unit having replaceable additive containers.

Moreover, an advantage of the present disclosure is to provide an additive dispensing unit that dispense a plurality of additive shots into a beverage.

Additional features and advantages are described herein, and will be apparent from, the following Detailed Description and the figures.

### BRIEF DESCRIPTION OF THE FIGURES

FIG. 1 illustrates an additive dispensing unit of the present disclosure in an embodiment.

FIG. 2 illustrates additive container pouches arranged in the additive dispensing unit of the present disclosure in an embodiment.

FIG. 3A illustrates pumps arranged in the additive dispensing unit of the present disclosure in another embodiment.

FIG. 3B illustrates a cross-section IIIB of a dispensing outlet of the pump in FIG. 3A.

FIG. 4 illustrates an additive dispensing unit operatively associated with a beverage dispensing machine of the present disclosure in another embodiment.

FIG. 5 illustrates an additive dispensing unit comprising additive bag in box packages or cartridges of the present disclosure in another embodiment.

FIG. 6 illustrates an additive dispensing unit comprising additive filled syringes with screw-based stepper motors of the present disclosure in another embodiment.

FIG. 7 illustrates an additive dispensing unit comprising solenoid actuators of the present disclosure in another embodiment.

FIG. 8 illustrates an additive dispensing unit comprising drop and load additive packages and dosing pumps of the present disclosure in another embodiment.

### DETAILED DESCRIPTION

The present disclosure generally relates to additive dispensing units and methods of using the additive dispensing units. The additive dispensing units can be added to a beverage dispensing machine to modify or enhance the characteristics of the beverage being dispensed. The additive dispensing units can be easy for an operator to access. In addition, the components of the additive dispensing units can be easily serviceable.

In the present specification, as used herein the term “modular” means a stand alone functional assembly of components that is adapted for use in conjunction with other machines or devices and/or to be coupled or secured thereto.

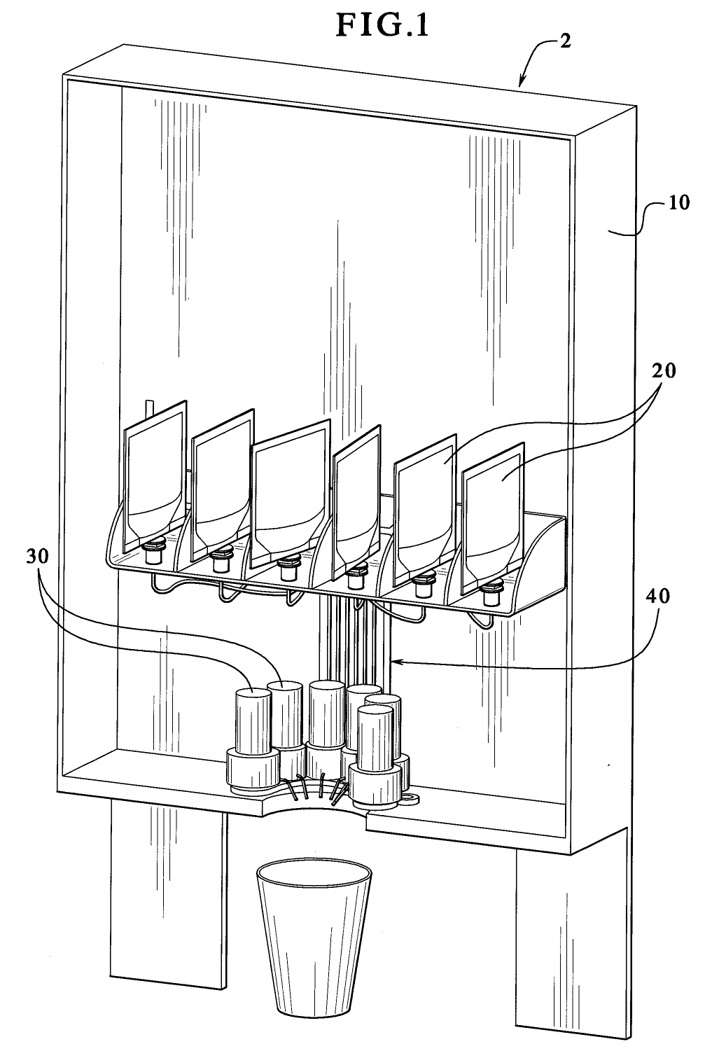

In an embodiment illustrated in FIGS. 1-3, the present disclosure provides a modular dispensing unit 2 comprising a support 10, a plurality of containers 20 having additives attached to the support 10 and a plurality of pumps 30 attached to the support. The support 10 can be a panel or door so constructed and arranged to fit onto any suitable beverage dispensing machine. For example, the dispensing unit can comprise a front panel of the beverage dispensing machine. In an alternate embodiment, the panel can be designed like a drawer to be inserted inside receiving or guiding elements of the beverage dispensing machine.

The support 10 can be configured to entirely surround the additive containers 20 and pumps 30 or just one side of the dispensing unit 2 as illustrated in FIG. 1. For example, in this embodiment, the open side exposing the additive containers 20 and pumps 30 would be facing toward the beverage dispensing machine when attached to it thereby hiding the additive containers 20 and pumps 30 from the view of the user. In a horizontal drawer arrangement, it should be understood that the distribution of the additive containers and pumps could be placed differently such as, for example, on a substantially horizontal support plane.

As used herein, additives are ingredients that can be added to a beverage to modify and/or enhance its characteristics. The additives can comprise, for example, a flavoring, flavor enhancer, nutritional supplement, coffee or tea booster, flavor masker, colorant, aromatic, a substance selected for adding body to a beverage base or combinations thereof. The additives can be in fluid or flowable form or any suitable form that can be pumped from the additive containers into the beverage holder.

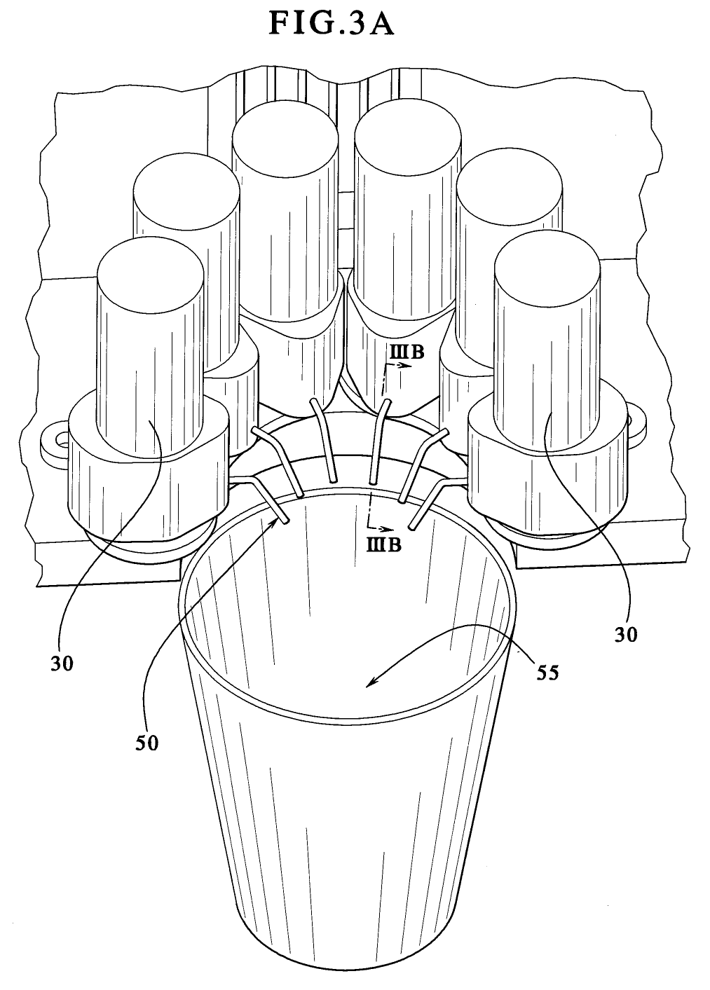

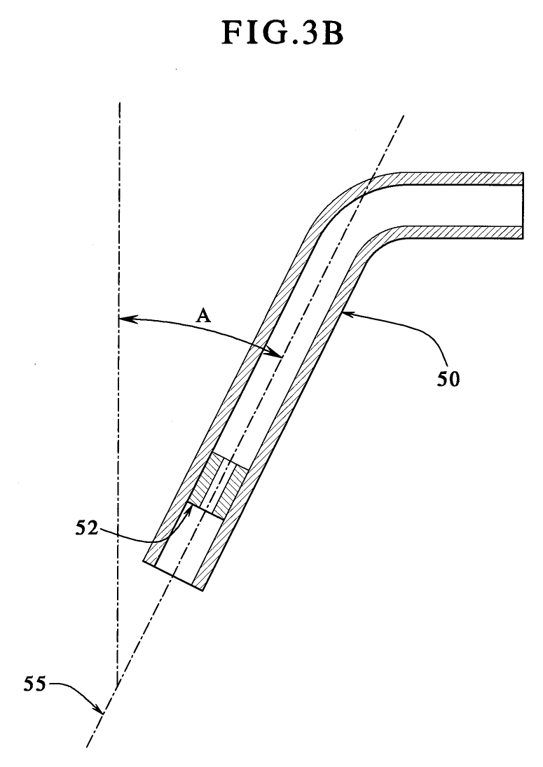

The pumps 30 can be operatively connected to the additive containers 20 and so constructed and arranged for dispensing one or more of the additives from the additive containers 20. The pumps 30 can be in fluid communication with the additive containers 20, for example, through flexible tubing 40 that connects each of the individual additive containers 20 to one or more individual pumps 30. In an alternative embodiment, the flexible tubing can be guided by and protected in rigid hollow profiles connected to the panel in a manner that oversized lengths of tubing is avoided. In another embodiment, the pumps can be so constructed and arranged in an arc formation above a dispensing area as illustrated in FIGS. 1 and 3A.

The pumps 30 can also have dispensing outlets 50 for releasing the additive into the beverage cup or holder as illustrated in FIG. 3A. For example, the dispensing outlets 50 can be capillary dispensing tubes for dispensing the additives. Benefits of having the pumps in an arc formation along with using capillary dispensing tubes can include anti-dripping dispensing capabilities and shorter distances from the dispensing unit into a beverage holder for accurate additive dosing (i.e. precise dispensed amounts).

In an alternative embodiment, one or more of the pumps can comprise a dispensing outlet 50 having a capillary tube insert 52 for providing the dispensing outlet 50 with capillary properties. For example, the tube insert 52 can be positioned inside the dispensing outlet 50 as illustrated in FIG. 3B. The inner diameter of the dispensing outlet 50 can be, for instance, about 0.062 inches and the inner diameter of the tube insert 52 can be about 0.020 inches. There can be about a 0.1 inch length between the tube insert 52 and the exit of the dispensing outlet 50 where the additive remains within the dispensing outlet 50 to reduce or prevent additive dripping. It should be appreciated that the dimensions of the dispensing outlet 50 and the tube insert 52 can be any suitable sizes in accordance with embodiments of the present disclosure. In an alternative embodiment, the dispensing outlet can form the capillary tube itself.

The dispensing outlet 50 can be oriented in the direction with a certain angle A relative to a vertical position and relatively toward the central passage 55 (FIG. 3B). The additive can be delivered with a certain velocity in the direction of a stream of a dispensed beverage base (e.g. base liquid) when the stream of the beverage base is vertically delivered through the passage 55. As a result, in-stream mixing will occur between the additive and the beverage base without the additive contacting a part of the dispenser. This further results in very little to no contamination of the parts of the dispenser by the additive. The angle A can vary, for example, between 5 and 90 degrees, preferably between 15 and 55 degrees. In-cup mixing may also occur when the angle A is small enough so that the additive reaches a surface of the beverage holder or the surface of the liquid as the liquid progressively rises up in the beverage holder.

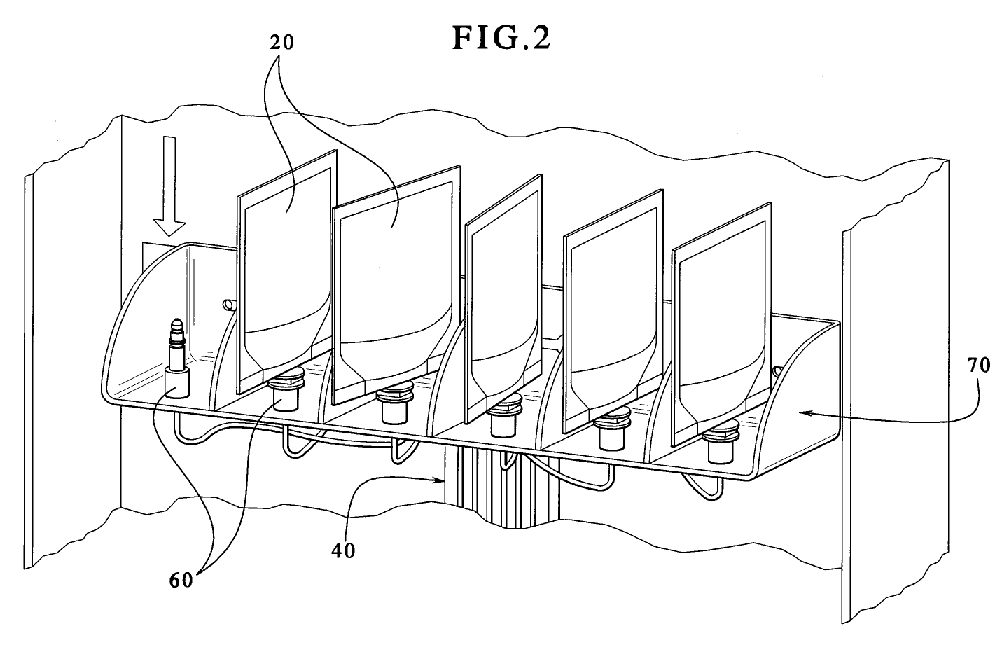

In an embodiment illustrated in FIG. 2, one or more of the additive containers 20 can be releaseably attached to fitments 60. The fitments 60 can be in fluid communication with the tubing 40 that connects to the pumps 30. The fitments 60 can comprise any suitable shape and material for providing a sealed attachment to the additive containers 20. In an embodiment, the fitments 60 can be attached to a shelf 70 designed for holding the additive containers 20. The shelf 70 can be attached to the support 10 in any suitable manner. The fitment can be a self-reclosable fitment such as CLEAN-CLIC® SPS-4 type fitments sold by the Dutch Company I.P.N.

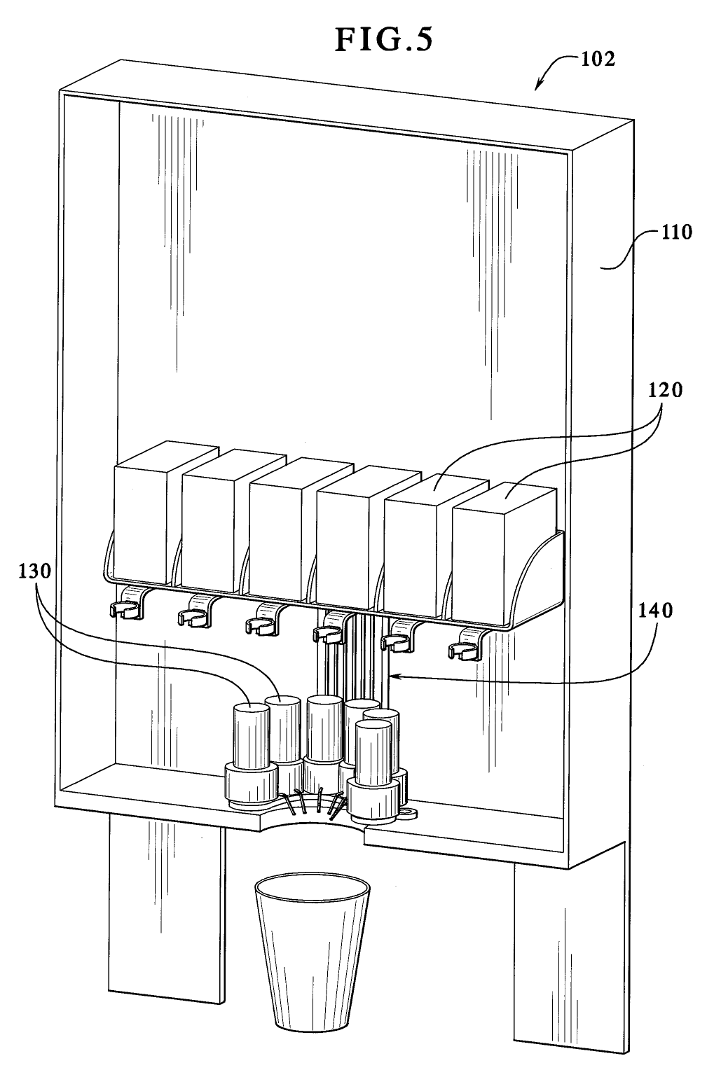

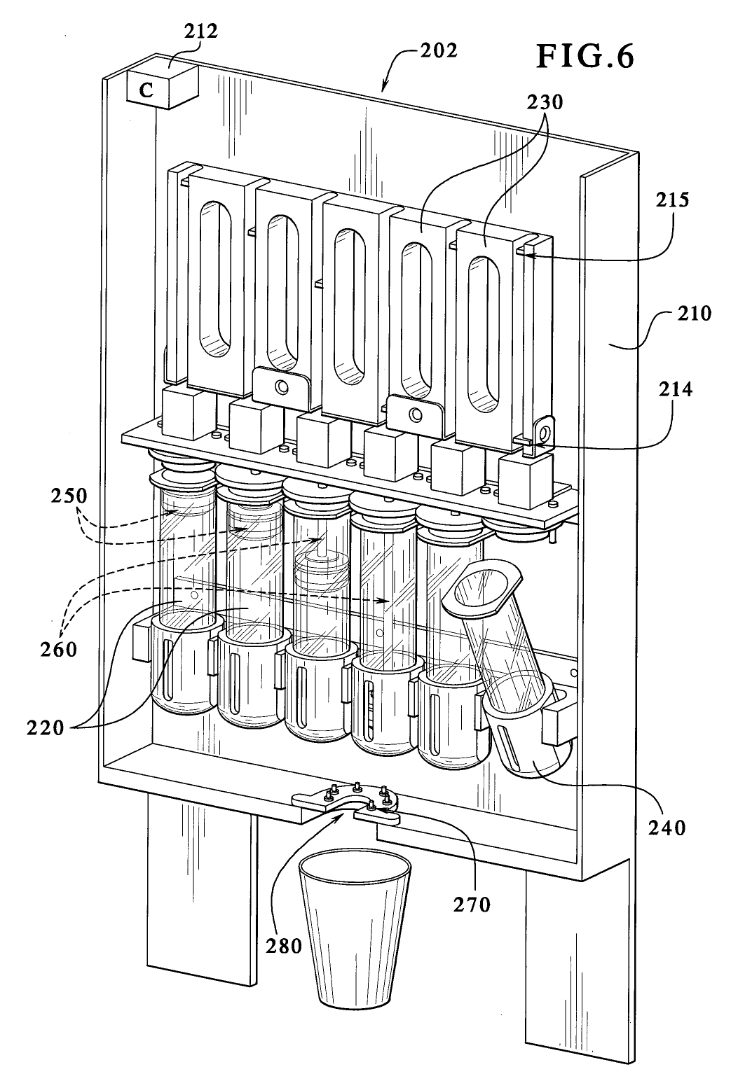

The additive containers 20 can comprise any material suitable for holding and releasing the additives. For example, one or more of the additive containers 20 can in the form of flexible pouches as illustrated in FIGS. 1-2. One or more of the additive containers can also be releaseably attached to the support for easy replacement when the additive container is empty. The additives containers can also comprise packages other than pouches such as, for example, bag-in-boxes or cartridges 120 as illustrated in FIG. 5 or syringes 220 as illustrated in FIG. 6.

In an embodiment, the pumps can comprise, for example, diaphragm pumps, peristaltic pumps, syringe pumps, piston pumps, piezoelectric pumps and/or any other suitable dosing pump. The pumps can also be releaseably attached to the support. For example, as illustrated in FIGS. 1 and 3A, the additive containers 20 can be connected by tubing 40 to the solenoid diaphragm pumps 30 that can be mounted in an arc fashion on the support 10 below the additive containers 20. Below the dispensing outlets 50 of the pumps 30 is the passage 55 through which one or more additive are discharged. The additives can be discharged directly into the beverage holder before, during or after the beverage has been added and/or the additives can be added into the stream of the beverage when the beverage is dispensed through the passage 55.

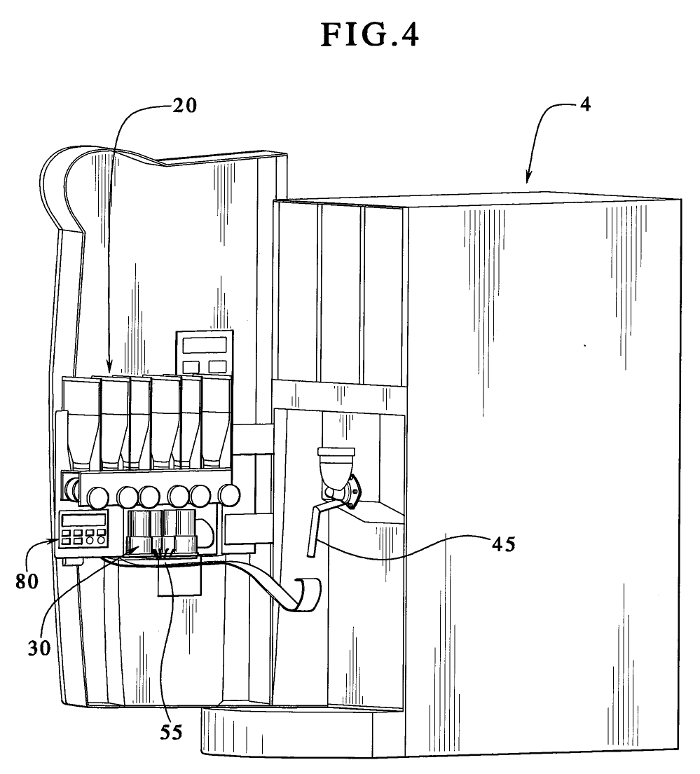

In an alternative embodiment illustrated in FIG. 4, the dispensing unit 2 can be so constructed and arranged to be attached to and operatively associated with a beverage dispensing machine 4. For example, the dispensing machine 4 can be designed with a beverage delivery outlet 45 that fits above the passage 55 when the dispensing unit 2 is assembled to the dispensing machine 4 in the operational beverage delivery position. The additive dispensing units in embodiments of the present disclosure can be in a stand alone modular form and adapted for easy addition to and removal from various models of beverage dispensing machines.

As illustrated in FIG. 4, the modular dispensing unit can further comprise a controller 80 operatively associated with the pumps 30 to vary the amount of one or more additives dispensed from the containers. For example, the controller 80 can be any suitable electronic device capable of operating (e.g. turning on/off, controlling speed) the pumps/pressure mechanisms used to dispense the additives from the containers. The controller can be connected to the pumps by any suitable mechanisms such as, for example, electrical wires or cables. The controller for the additive dispensing units can be operated manually or automatically, for example, by preprogrammed software.

It should be appreciated that the controller can be on the additive dispensing unit or on a beverage dispensing machine associated with the additive dispensing unit. If the controller is on the beverage dispensing machine, the pumps can be connected so as to be in operative communication with the controller. For example, the pumps can be connected electronically via a cable to a circuit board that resides inside the body of the beverage dispensing machine. The pumps can be controlled to accurately dispense about 4-6 types of additive shots. It should be appreciated that the pumps can be controlled to allow up any suitable number and volume of different additives into the beverage holder.

The controller can be also configured for causing the dispensing unit to start dispensing one or more of the additives after and in response to the start of a base liquid dispensed by the beverage dispensing machine. The controller can be configured for causing the pumps to dispense one or more of the additives in pulses of a predetermined duration.

In another embodiment illustrated in FIG. 6, the present disclosure provides a modular dispensing unit 202 comprising a support 210, a plurality of syringes 220 having additives attached to the support 210 and a plurality of pressure mechanisms 230 attached to the support 210. For example, in this embodiment, the pressure mechanisms 230 can comprise screw-based stepper motors. The pressure mechanism can comprise other suitable types of stepper motors such as rod-based stepper motors.

The pressure mechanisms 230 can be operatively coupled to the syringes 220 and so constructed and arranged for dispensing one or more of the additives from the syringes 220 by applying pressure to the syringes 220. As a result, the additives are dispensed from the outlets of the syringes and directed into a beverage holder via dispensing outlets (not shown) attached to the outlets of the syringes 220.

The syringes 220 can be releaseably attached to the support 210. In the illustrated embodiment, the support 210 comprises individual syringe holders 240 forming small portions into which the lower portion of the syringe can releasably be inserted. The syringe holders 240 can be further mounted along transversal pivots, for example, between an upright holding position and an inclined loading position, to facilitate insertion of the syringes 220 in the relatively confined space of the support 210.

In an embodiment, the dispensing unit 202 can further comprise a controller 212 associated with the pressure mechanisms to vary the amount of one or more additives dispensed from the syringes. The controller 212 can also be associated with the pressure mechanisms 230 to retract it at the end of each dispensing cycle of the additive in order to eliminate the droplet formation at the end of each stroke. A low level sensor 214 can also be provided to detect a low level of additive in the syringe. The low level sensor 214 is placed to sense the lowest possible position of the piston's rod 260. As a result of a low level of an additive in the syringe, a warning signal can be sent by the controller to an information board of the machine and/or command an automatic retraction of the pressure mechanism 230 thereby facilitating the exchange of the syringes in the dispensing unit 202. Similarly, an upper stop switch 215 can be placed to sense the highest possible position of the piston's rod 260 whereby the piston becomes disengaged from the syringe 220 to enable the replacement of the empty syringe with a full syringe.

The syringes can be designed to be part of a disposable or recyclable assembly. Preferably, the syringes have a rigid plastic body. A piston type lid 250 can be slidably mounted inside the body and be permanent part of the syringe. The piston can by actuated by pressure via a pusher 260 of the pressure mechanism 230. The pusher 260 is preferably a permanent part of the dispensing unit 202.

At the additive delivery side, in an embodiment, the unit comprises an arc-shaped distribution of additive nozzles 270 about a central passage 280. The nozzles can be linked to an additive connector placed at the lowest point of the syringe holders via tubings (not shown). The nozzles can be mounted on the support to be removed for replacement and/or cleaning.

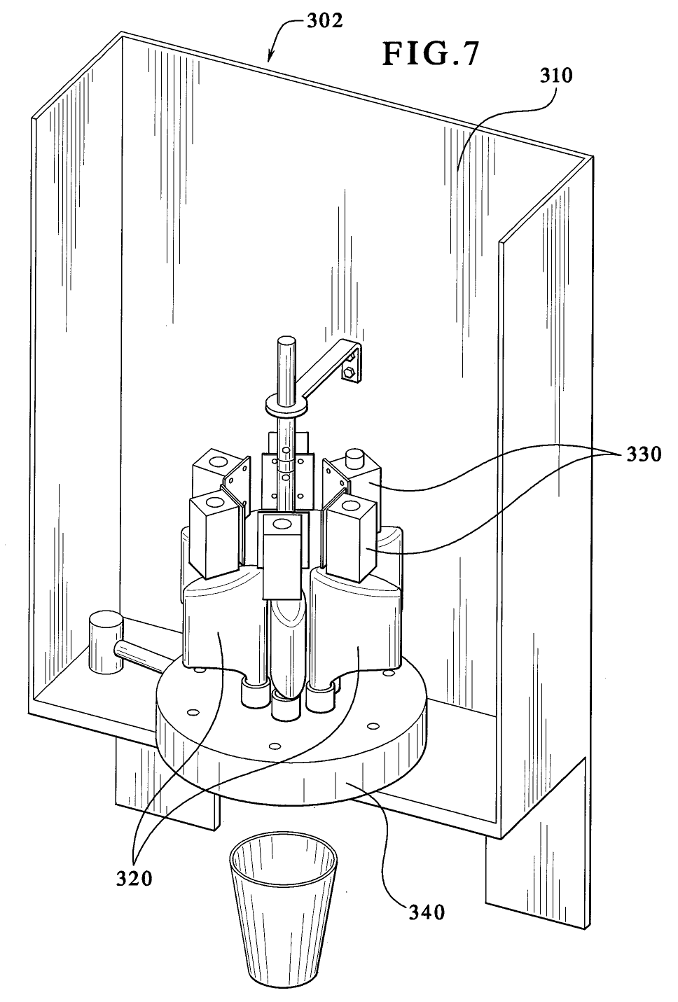

In an alternative embodiment illustrated in FIG. 7, the present disclosure provides a modular dispensing unit 302 comprising a support 310, a plurality of containers 320 having additives attached to the support 302 and a plurality of pressure mechanisms 330 attached to the support 302. The carousel can allow for easy cleaning and maintenance of the additive containers and pressure mechanisms.

In this embodiment, the pressure mechanisms 330 can comprise solenoid actuators or any other suitable pressure device. The pressure mechanisms 330 can be operatively coupled to the additive containers 320 and constructed and arranged for dispensing one or more of the additives from the containers 320 by applying pressure to the containers 320. The additive containers 320 can comprise a flexible material that becomes compressed by the pressure mechanisms 330 thereby releasing the additives through outlets on the additive containers 330.

As illustrated in FIG. 7, the dispensing unit 302 can further comprise a carousel 340 hingedly attached to the support 310. The plurality of containers 320 can be releaseably attached to the carousel 340 and the plurality of pressure mechanisms 330 can be arranged above the additive containers 320. For example, the pressure mechanisms 330 can be operatively coupled to the additive containers 320 and so constructed and arranged for applying pressure to the additive containers 320. As a result, the additives are dispensed from outlets of the additive containers 320 and directed into a beverage holder via dispensing outlets (not shown) attached to the outlets of the additive containers 320.

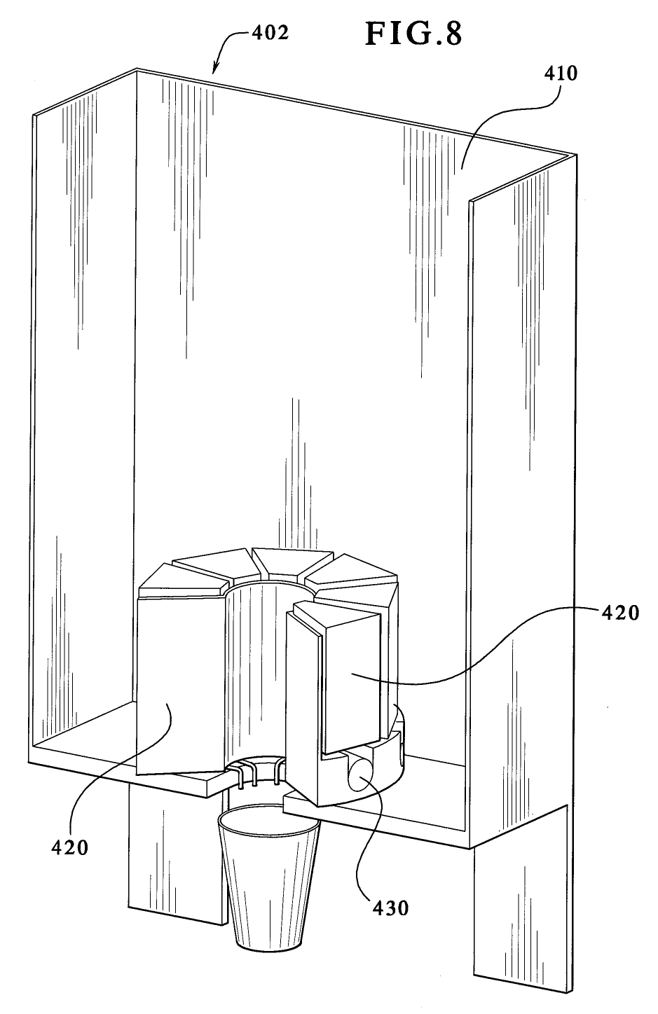

In an alternative embodiment illustrated in FIG. 8, the present disclosure provides a modular dispensing unit 402 comprising a support 410, a plurality of drop and load cartridges 420 having additives attached to the support and a plurality of dosing pumps 430 attached to the support 410. This embodiment functions in a similar manner as those previously discussed.

In another embodiment, the present disclosure provides a method of preparing a beverage using a modular additive dispensing unit. The beverage can comprise a component such as protein-enriched liquid, juice, coffee, tea, cocoa, milk, a cereal or a combination thereof.

The method can comprise providing a base liquid from a beverage dispensing machine in a beverage holder; dispensing a plurality of additives from an additive dispensing unit into the beverage holder to mix the additives with the base liquid to provide a beverage, wherein the additives are dispensed from a plurality of containers by a plurality of pumps operatively connected to the containers; and controlling the dispensing of additives to vary the concentration of the additives in the base liquid in the beverage holder during the dispensing.

In this method, the modular additive dispensing unit is operatively associated with the beverage dispensing machine. The modular additive dispensing unit can be operatively associated with the beverage dispensing machine and controlled by the beverage dispensing machine so that the addition of one or more of the additives can be coordinated with the dispensing of the beverage. For example, the controller can cause the additive dispensing unit to dispense one or more additives before, during or after the beverage is dispensed from the beverage machine.

In an alternative embodiment, the present disclosure provides another method of preparing a beverage. In this embodiment, the method can comprise mixing a concentrate beverage component with a first liquid to provide a base liquid; dispensing the base liquid from a beverage dispensing machine into a beverage holder; dispensing a plurality of additives from an additive dispensing unit into the beverage holder to mix the additives with the base liquid during the dispensing of the base liquid to provide a beverage, wherein the additives are dispensed from a plurality of containers by a plurality of pumps operatively connected to the containers; and controlling the dispensing of additives to vary the concentration of the additives in the base liquid in the beverage holder during the dispensing.

In another embodiment, the method comprises mixing a concentrate beverage component with a first liquid to provide a base liquid; dispensing the base liquid from a beverage dispensing machine in the direction of a beverage holder; dispensing a plurality of additives from an additive dispensing unit into a stream of the base liquid to mix the additives with the base liquid during the dispensing of the base liquid to provide a beverage. The additives can be dispensed from a plurality of containers by a plurality of pumps operatively connected to the containers.

The method can further comprise dispensing the base liquid and additives for predetermined time periods automatically in response to operating a dispensing control. For example, the additives can be dispensed in a plurality of pulses of predetermined durations, the base liquid being dispensed at least before and at the beginning of the pulses. The additives can be dispensed from fewer than all of the plurality of containers to make a single beverage.

In an embodiment, the method can further comprise operating a selection control of the beverage dispensing machine to select one or more of the additive containers from which to dispense the additive.

The method can further comprise whipping the beverage component and the liquid to produce a foam layer on a liquid layer in the dispensed base liquid. The beverage component can comprise an ingredient such as a coffee, cocoa, or tea base, a sweetener, a whitener or combinations thereof. The whitener can be a non-dairy creamer, a dairy creamer or combinations thereof.

It should be appreciated that the additive dispensing unit can be designed so as to require little to no cleaning. The additives can be shelf-stable so there is no need to pull the tubing apart for cleaning or rinsing out. The additive dispensing unit can be any suitable length, height and depth for containing the additive containers and pumps or pressure mechanisms.

All of the components of the additive dispensing units can be at the front of the machine, allowing easy access for a consumer or foodservice operator to add/replace additional additive containers when the unit is empty. In addition, the additive dispensing unit provides easy access for servicing the additive dispensing components should there be any electrical or mechanical issues. The additive dispensing units should not interfere with loading the main beverage packages or servicing the body of the beverage dispensing machine.

Because the additive dispensing units dispense nutritional or flavor additives directly into the beverage holder or cup in an embodiment, there can be little to no need to clean any components of the additive dispensing units such as the tubing, additive containers or pumps. Additive storage and preparation is contained in packaging containers, which can be disposable. This provides a hygienic beverage machine and saves the machine operator servicing time. Further, because the additive dispensing units dispense nutritional or flavor additives directly into a beverage holder or cup and/or into the a stream of the beverage base, there is no additive carryover from one serving to the next.

In an alternative method for dispensing nutritional or flavor additives in the beverage, one or more additives can be directed into a stream of a diluting liquid (e.g. an amount of water), before mixing of the diluting liquid with a beverage concentrate to form the beverage. In another possible method, one or more additives can be directed into a stream of a beverage concentrate before the beverage concentrate is mixed with a diluting liquid to form the beverage.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A modular dispensing unit comprising:
a support;
a plurality of containers comprising additives, the containers attached to the support; and
a plurality of pumps attached to the support, wherein the pumps are operatively connected to the containers for dispensing one or more of the additives from the containers, wherein the dispensing unit is so constructed and arranged to be attached to and operatively associated with a beverage dispensing machine.

2. The dispensing unit of claim 1, wherein the dispensing unit comprises a front panel of the beverage dispensing machine.

3. The dispensing unit of claim 1 comprising a controller operatively associated with the pumps to vary the amount of one or more additives dispensed from the containers.

4. The dispensing unit of claim 3, wherein the controller is configured for causing the dispensing unit to start dispensing one or more of the additives after and in response to the start of a base liquid dispensing by the beverage dispensing machine.

5. The dispensing unit of claim 3, wherein the controller is configured for causing the pumps to dispense one or more of the additives in pulses of a predetermined duration.

6. The dispensing unit of claim 1, wherein the pumps are so constructed and arranged in an arc formation above a dispensing area.

7. The dispensing unit of claim 1, wherein at least one of the pumps comprises a capillary dispensing tube for dispensing the additives.

8. The dispensing unit of claim 1, wherein at least one of the pumps comprises a dispensing outlet having a capillary insert for dispensing the additives.

9. The dispensing unit of claim 1, wherein the additives are selected from the group consisting of a flavoring, flavor enhancer, nutritional supplement, coffee or tea booster, flavor masker, colorant, aromatic, a substance selected for adding body to a beverage base and combinations thereof.

10. The dispensing unit of claim 1, wherein the pumps are in fluid communication with the containers.

11. The dispensing unit of claim 1, wherein one or more of the containers are releaseably attached to the support.

12. The dispensing unit of claim 1, wherein one or more of the containers are releaseably attached to fitments in fluid communication with the pumps.

13. The dispensing unit of claim 12, wherein one or more of the pumps are part of the containers.

14. The dispensing unit of claim 1, wherein one or more of the containers are flexible.

15. The dispensing unit of claim 1, wherein one or more of the pumps are releaseably attached to the support.

16. The dispensing unit of claim 1, wherein the pumps are selected from the group consisting of diaphragm pumps, peristaltic pumps, syringe pumps, piston pumps, piezoelectric pumps and combinations thereof.

17. A modular dispensing unit comprising:
a support;
a plurality of syringes comprising additives, the syringes attached to the support; and
a plurality of pressure mechanisms attached to the support, wherein the pressure mechanisms are operatively coupled to the syringes and are so constructed and arranged for dispensing one or more of the additives from the syringes by applying pressure to the syringes.

18. The dispensing unit of claim 17, wherein the pressure mechanisms comprise stepper motors.

19. The dispensing unit of claim 17, wherein the syringes are releaseably attached to the support.

20. The dispensing unit of claim 17 comprising a controller associated with the pressure mechanisms to vary the amount of one or more additives dispensed from the syringes.

21. The dispensing unit of claim 17 comprising a controller associated with the pressure mechanisms to retract the pressure mechanisms at the end of each dispensing cycle of the additive.

22. The dispensing unit of claim 17, wherein the dispensing unit is operatively associated with a beverage dispensing machine.

23. A modular dispensing unit comprising:
a support;
a plurality of containers comprising additives, the containers attached to the support; and
a plurality of pressure mechanisms attached to the support, wherein the pressure mechanisms are operatively coupled to the containers and are so constructed and arranged for dispensing one or more of the additives from the containers by applying pressure to the containers.

24. The dispensing unit of claim 23, wherein the pressure mechanisms comprise solenoid actuators.

25. The dispensing unit of claim 23, wherein the dispensing unit is operatively associated with a beverage dispensing machine.

26. The dispensing unit of claim 23, wherein the containers are releaseably attached to the support.

27. A modular dispensing unit comprising:
a support;
a carousel hingedly attached to the support;
a plurality of containers comprising additives, the containers attached to the carousel; and
a plurality of pressure mechanisms attached to the carousel, wherein the pressure mechanisms are operatively coupled to the containers and are so constructed and arranged for dispensing one or more of the additives from the containers by applying pressure to the containers.

28. A modular dispensing unit comprising:
a support;
a plurality of containers comprising additives, the containers attached to the support; and
a pump attached to the support, wherein the pump is operatively connected to the containers for dispensing the additives from the containers and wherein the dispensing unit is so constructed and arranged to be attached to and operatively associated with a beverage dispensing machine.

29. A method of preparing a beverage, the method comprising:
dispensing a base liquid from a beverage dispensing machine in a beverage holder;
dispensing a plurality of additives from a modular additive dispensing unit into the beverage holder or into a dispensed base liquid stream to mix the additives with the base liquid to provide a beverage, wherein the additives are dispensed from a plurality of containers by a plurality of pumps operatively connected to the containers and wherein the modular additive dispensing unit is operatively associated with the beverage dispensing machine; and
controlling the dispensing of additives to vary the concentration of the additives in the base liquid in the beverage holder during the dispensing.

30. The method of claim 29, further comprising dispensing the base liquid and additives for predetermined time periods automatically in response to operating a dispensing control.

31. The method of claim 29, wherein the additives are dispensed in a plurality of pulses of predetermined durations, the base liquid being dispensed at least before and at the beginning of the pulses.

32. The method of claim 29, wherein the additives are dispensed from fewer than all of the plurality of containers to make a single beverage.

33. The method of claim 29, further comprising operating a selection control of the beverage dispensing machine to select one or more of the additive containers from which to dispense the additive.

34. The method of claim 29, wherein the additives are selected from the group consisting of flavorings, nutritional supplements, coffee or tea boosts, sweeteners, flavor enhancers or reducers, colorants, aromatics, a substance formulated to add body to the liquid base and combinations thereof.

35. The method of claim 29, wherein the concentrate beverage component is selected from the group consisting of protein-enriched liquid, juice, coffee, tea, cocoa, milk, a cereal, or a combination thereof.

36. The method of claim 29, wherein the beverage component comprises an ingredient selected from the group consisting of a coffee, cocoa, or tea base, a sweetener, a whitener and combinations thereof.

37. The method of claim 36, wherein the whitener comprises a component selected from the group consisting of a non-dairy creamer, a dairy creamer and combinations thereof.

38. A method of preparing a beverage, the method comprising:
mixing a concentrate beverage component with a first liquid to provide a base liquid;
dispensing the base liquid from a beverage dispensing machine into a beverage holder;
dispensing a plurality of additives from a modular additive dispensing unit into the beverage holder or into a dispensed based liquid stream to mix the additives with the base liquid during the dispensing of the base liquid to provide a beverage, wherein the additives are dispensed from a plurality of containers by a plurality of pumps operatively connected to the containers and wherein the modular additive dispensing unit is operatively associated with the beverage dispensing machine; and
controlling the dispensing of additives to vary the concentration of the additives in the base liquid in the beverage holder during the dispensing.

39. A method of preparing beverages at a location, the method comprising:
dispensing a first beverage and a second beverage from a beverage dispensing machine;
dispensing a first additive from a modular additive dispensing unit into the first beverage to mix the first additive with the first beverage;
dispensing a second additive from the modular additive dispensing unit into the second beverage to mix the second additive with the second beverage; and
controlling the dispensing of the additives to vary the concentration of the additives in the first beverage and the second beverage.
